(19) United States
(12) Patent Application Publication
(10) Pub. No.: US 2005/0258315 A1
(43) Pub. Date: Nov. 24, 2005

(54) Conduit support apparatus

(76) Inventor: Paul Bigham, Healdsburg, CA (US)

Correspondence Address: JOHNSON & STAINBROOK, LLP, 3558 ROUND BARN BLVD., SUITE 203, SANTA ROSA, CA, 95403, US

(21) Appl. No.: 11/122,197

(22) Filed: May 3, 2005

Related U.S. Application Data
(60) Provisional application No. 60/567,697, filed on May 3, 2004.

(51) Int. Cl. F16L 3/08

(52) U.S. Cl. 248/74.3

(57) ABSTRACT

A snap-on bracket can be used to suspend conduit, pipes, wires, AC and furnace lines, and the like beneath a floor joist or other frame or structural member. The apparatus includes a generally U-shaped bracket portion of a size to snugly fit over the edge of a board such as is commonly used for floor joists. A plurality of inwardly-directed teeth elements on the inside surfaces of the walls of the bracket portion facilitate grasping of the joist. A downwardly-depending strap portion extends from the base of the bracket, such that the strap can be wrapped around the conduit to be suspended beneath the joist, and secured to itself or the bracket to support and fix the conduit in place.

### CROSS REFERENCE TO RELATED APPLICATIONS

The present application claims the benefit of the filing date of U.S. Provisional Patent Application Ser. No. 60/567,697, filed 3 May 2004.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to tools and hardware, and more particularly to an improved support bracket apparatus that can be used to suspend conduit, pipes, wires, and the like beneath a floor joist or other structural member.

### BACKGROUND INFORMATION AND DISCUSSION OF RELATED ART

Residential and commercial construction often requires the installation of pipes, conduit, wires, or other construction material beneath a floor or other surface, such as during the installation of air conditioning and heating equipment. Such installation typically involves the suspending of the conduit or pipe from a floor joist, beam, or other structural frame member, utilizing segments of metal or plastic strap material that are nailed or otherwise secured to the joist. This practice is awkward, labor-intensive, and time-consuming, especially in the cramped and dark confines of a crawl space beneath a floor.

Some hardware devices have been proposed to address this problem. For example, U.S. Pat. No. 5,845,882 to Hodges et al. discloses a pipe hanger for suspending a pipe from a support structure at a variety of angles and includes a stem and a flexible hook attached to the stem. The stem has at least one groove suitable for accepting a staple for hanging the pipe hanger from the support structure. The grooves may be polygonal, allowing the pipe hanger to be suspended at a variety of angles. The hook has a curved portion to accept a pipe in a snap-fit position. The stem may be shortened to a suitable length by severing the stem at any one of the grooves.

U.S. Pat. No. 6,152,412 to Basickes et al. describes a pipe hanger which has a tubular section which is split axially so that the tubular section can be opened and fit around a pipe. Two partially overlapping tabs extend from the tubular section. When the tabs are urged together, holes in the tabs become aligned, and permit a single fastener to secure the tabs together, and to affix the hanger to a support structure. The hanger therefore requires only a single fastener. The fastener is preferably supplied with the hanger, and is held by friction in one of the holes in the tabs, or in a tubular chamber extending from one of the tabs. The shape of the tubular section facilitates manual closing of the tubular section around the pipe. The hanger is very easy to install, even when the hanger is located in an inconvenient position.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The conduit support apparatus of the present invention provides a snap-on bracket that can be used to suspend conduit, pipes, wires, AC and furnace lines, and the like beneath a floor joist or other frame or structural member. The inventive apparatus includes a generally U-shaped bracket portion constructed from 20 gauge sheet metal or other suitable material, of a size to snugly fit over the edge of a board (e.g., a 2″ by x″ board with 1⅝″ inside dimension), such as is commonly used for floor joists. A plurality of inwardly-directed teeth elements on the inside surfaces of the walls of the bracket portion facilitate grasping of the rafter, joist, or other frame member on which the bracket has been inserted. A downwardly-depending strap portion extends from the base of the bracket portion, such that the strap can be wrapped around the pipe, conduit, or other item to be suspended beneath the frame member, and secured to itself or the bracket to support and fix the pipe in place.

The apparatus can thus be inserted onto the frame member, and the strap wrapped around the item to be suspended and secured, without the use of tools. This makes the inventive apparatus ideally suited for use in crawl spaces or other confined areas.

It is therefore an object of the present invention to provide a new and improved conduit support bracket.

It is another object of the present invention to provide a new and improved conduit support bracket that can be used in a crawl space or other confined area.

A further object or feature of the present invention is a new and improved support bracket for wires and pipes.

An even further object of the present invention is to provide a novel method for holding AC and furnace lines beneath a house.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a preferred embodiment of a conduit support apparatus of this invention;

FIG. 2 is a top plan view of the conduit support apparatus of FIG. 1;

FIG. 3 is an end elevation view in partial cross-section of the conduit support apparatus of FIG. 1 as installed on a floor joist and supporting a conduit;

FIG. 4 is a side elevation view of a pair of conduit supports of this invention on a single floor joist, supporting a conduit longitudinally along the length of the joist;

FIG. 5 is an end elevation view in partial cross-section of a pair of conduit supports of this invention on a pair of adjacent floor joists, supporting a conduit laterally across the span between the joists; and

FIG. 6 is a perspective view of an alternate embodiment of a conduit support apparatus of this invention.

### DETAILED DESCRIPTION OF THE INVENTION

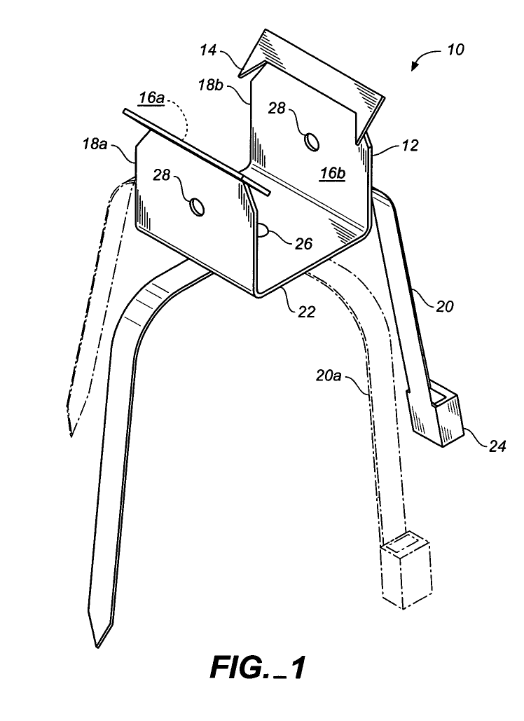

Referring to FIGS. 1 through 6, wherein like reference numerals refer to like components in the various views, there is illustrated therein a new and improved conduit support apparatus, generally denominated 10 herein.

FIG. 1 is a perspective view of a preferred embodiment of a conduit support apparatus 10 of this invention. Apparatus 10 includes a generally U-shaped bracket portion 12 constructed from 20 gauge sheet metal or other suitable material, such that the U-shape is of a size to snugly fit over the edge of a 2″ by x″ board (e.g., 1⅝″ inside dimension), such as is commonly used for floor joists. A plurality of inwardly-directed teeth elements 14 on the inside surfaces 16a, 16b of the walls 18a, 18b of the bracket portion facilitate grasping of the joist or other frame member on which the bracket will be inserted. A downwardly-depending strap portion such as cable tie 20 extends from the base 22 of the bracket portion, such that the cable tie can be wrapped around the conduit to be suspended beneath the joist, and secured to itself at cable tie head portion 24 to support and fix the conduit in place.

Cable tie 20 is preferably pivotally connected to base 22 by swivel fastener 26, so that the cable tie may be rotated about the swivel axis to accommodate conduit from any direction, as illustrated by the alternate cable tie position 20a in phantom. Apertures 28 may be formed in bracket walls 18a, 18b to facilitate penetration by a nail, screw, or other fastener.

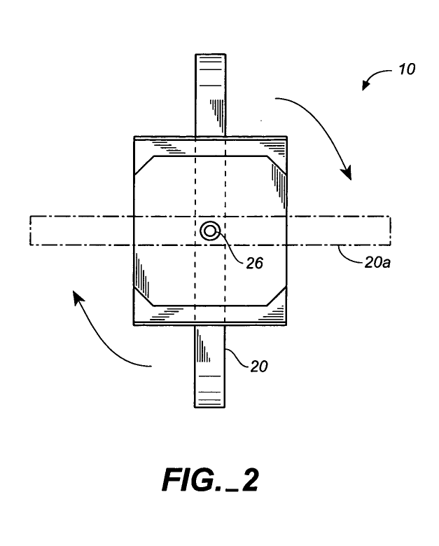

FIG. 2 is a top plan view of the conduit support apparatus 10 of FIG. 1. Swivel 26 permits rotation of the cable tie to any angle relative to bracket base 22.

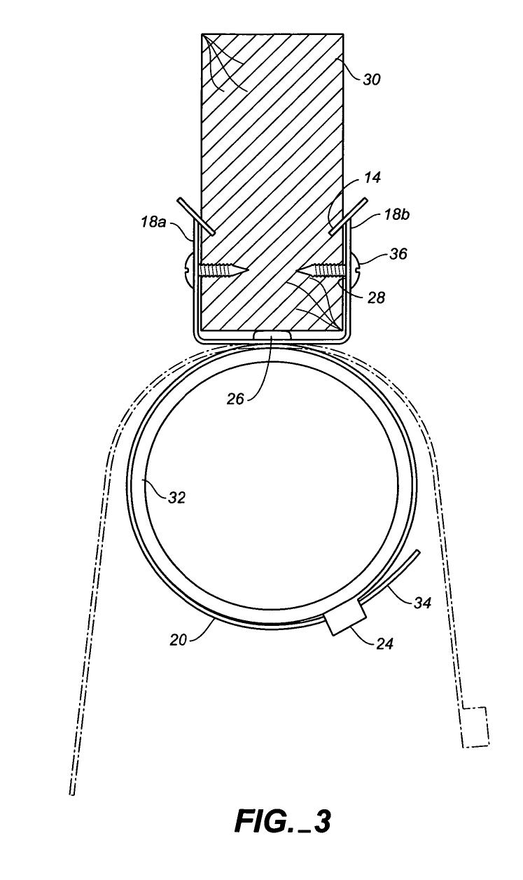

FIG. 3 is an end elevation view in partial cross-section of the conduit support apparatus 10 of FIG. 1 as installed on a floor joist 30 and supporting a conduit 32 by insertion of the free end 34 of cable tie 20 through cable tie head 24, in a manner well known in the art. This view further illustrates bracket teeth 14 engaging the sides of the joist 30, and screws 36 installed through apertures 28 to further strengthen the connection between the bracket 12 and joist 30. In some installations, engagement of the teeth 14 onto the joist will provide a sufficient connection, and use of screws or other fasteners will not be necessary. In such installations, the user may simply manually push the bracket up onto the joist to secure it there, and strap the conduit in place, thereby avoiding the use of tools or fasteners.

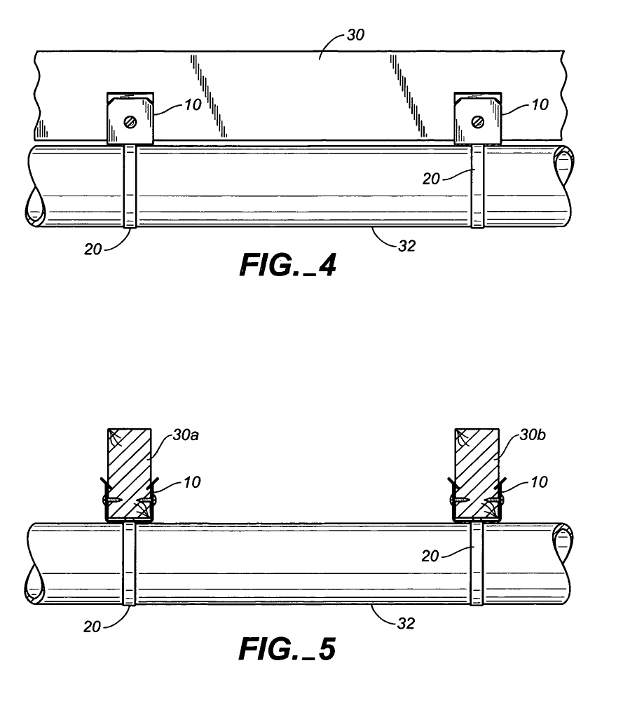

FIG. 4 is a side elevation view of a pair of conduit supports 10 of this invention on a single floor joist 30, supporting a conduit 32 longitudinally along the length of the joist. This cable tie orientation is similar to that depicted in FIG. 1 (solid lines) and FIG. 3.

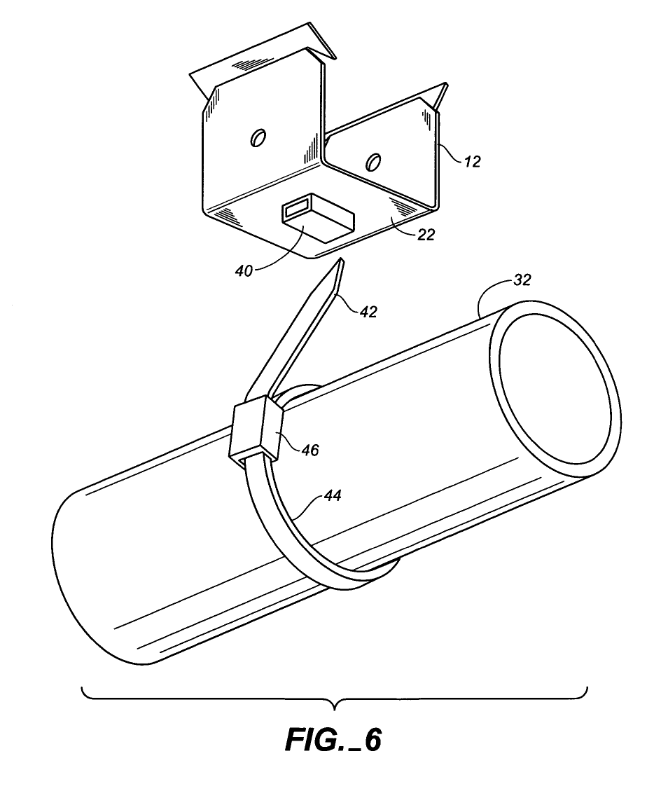

FIG. 5 is an end elevation view in partial cross-section of a pair of conduit supports 10 of this invention on a pair of adjacent floor joists 30a, 30b, supporting a conduit 32 laterally across the span between the joists. This cable tie orientation is similar to that depicted in FIG. 1 (phantom lines).

FIG. 6 is a perspective view of an alternate embodiment of a conduit support apparatus of this invention. In this embodiment, a cable tie head portion 40 or its equivalent (i.e., a receiver to capture the free end of a cable tie) is fixedly or pivotally connected to the base 22 of bracket 12. Free end 42 of discrete cable tie 44 is first inserted through cable tie head 46 to tightly surround conduit 32. Free end 42 is then inserted into and captured by head portion 40 on bracket 12, to suspend the conduit 32 from the bracket. This embodiment may be superior in certain conduit installation applications, and permits repeated use of the installed bracket by cutting the cable tie from the bracket, and using a new cable tie for subsequent use.

Further alternative versions of the inventive conduit support may be produced. For example, instead of a permanent connection between the cable tie and the bracket base, the bracket base may include integral slots to accommodate a separate cable tie. Alternatively, instead of a cable tie, a wire or other strap may be welded or otherwise secured to the bracket, and tied to or otherwise attached to the conduit being supported.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A conduit support apparatus for securing a conduit to a structural member, said conduit support apparatus comprising:
a U-shaped bracket portion including a pair of walls and a base, said walls including a plurality of inwardly-directed teeth elements; and
a downwardly-depending strap portion connected to said base, wherein said strap portion can be wrapped around the conduit to suspend the conduit beneath the structural member.

2. The conduit support apparatus of claim 1 wherein said downwardly-depending strap portion comprises a cable tie.

3. The conduit support apparatus of claim 1 wherein said downwardly-depending strap portion is pivotally connected to said base so that the strap portion may be rotated about the connection axis to accommodate conduit from any direction.

4. The conduit support apparatus of claim 1 wherein said walls include apertures to facilitate penetration by a fastener.

5. The conduit support apparatus of claim 1 wherein said bracket portion is constructed of sheet metal.

6. The conduit support apparatus of claim 1 wherein said U-shaped bracket portion has an inside dimension of approximately 1⅝ inches.

7. The conduit support apparatus of claim 1 wherein said downwardly-depending strap portion comprises a bracket-mounted cable tie head portion affixed to said base, and a discrete cable tie including a free end adapted for insertion into and capture by said bracket-mounted cable tie head portion.

8. The conduit support apparatus of claim 7 wherein said bracket-mounted cable tie head portion is pivotally affixed to said base.
